(19) United States
(12) Patent Application Publication
(10) Pub. No.: US 2013/0054359 A1
(43) Pub. Date: Feb. 28, 2013

(54) Computer System for Generating Recommendations to a Customer About Being Greener

(71) Applicants: Erik Stephen Ross, Charlotte, NC (US); Ellen Howse Brannen, Bear, DE (US); Chaoyen Wang, Wilmington, DE (US)

(72) Inventors: Erik Stephen Ross, Charlotte, NC (US); Ellen Howse Brannen, Bear, DE (US); Chaoyen Wang, Wilmington, DE (US)

(73) Assignee: Bank of America, Charlotte, NC (US)

(21) Appl. No.: 13/216,699

(22) Filed: Aug. 24, 2011

(51) Int. Cl. G06Q 30/00; G01C 21/34

(52) U.S. Cl. 705/14.53; 705/1.1

(57) ABSTRACT

A computer system obtains purchase history data about past purchases from merchants by a customer. Based on location information about the merchants, the computer system determines a bundled travel plan so that the customer may travel to the merchants in a single trip to reduce a trip characteristic such as travel time, mileage, gasoline usage, or a combination thereof. The computer system may further send map information to a terminal device to display the bundled travel plan to facilitate navigation by the customer. The computer system may also provide a suggested purchase alternative for one of the past purchases by a customer. For example, the computer system may consider different factors including the relative degree of greenness between the past purchase and the suggested purchase alternative based on carbon footprints.

### FIELD

Aspects of the embodiments relate to a computer system that processes transaction data to support a green incentive program.

### BACKGROUND

Environmentalism (often represented by the color green and referred as the green movement) is a broad philosophy regarding concerns for environmental conservation and improvement of the state of the environment. Environmentalism encompasses a social movement that seeks to influence the political process by lobbying, activism, and education in order to protect natural resources and ecosystems. The environmental movement may span different aspects that include management of resources, protection of the natural environment through public policy and individual behavior, health, and human rights.

While world governments may support the environmental movement through treaties such as the Kyoto Protocol and the Copenhagen Accord, individuals may want to participate directly in the green movement. For example, some individuals try to reduce their carbon footprint by buying products with recycled content and other environmentally friendly products, which may be identified by labeling on the products. Many businesses also often want to participate in the green movement and are happy to provide environmentally conscientious products. However, businesses may just not be aware that these products are available or understand what customers really want. For example, while hybrid cars are generally more efficient than traditional gas-powered cars, the increased price of a hybrid car may not be justified by the savings in gasoline costs. Nevertheless, the demand for hybrid cars is high because many consumers want them. Businesses need to know what is important to their customers and thus keep informed about the marketplace. Conversely, businesses need to inform customers about available choices of environmentally friendly (green) products. Consumers then can decide whether to purchase a product based on the price of the product as well as on the green characteristics of the product.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the embodiments address one or more of the issues mentioned above by disclosing methods, computer readable media, and apparatuses that process transaction data about a customer's purchase. The computer system may access green index data that includes information about environmentally green purchases for green purchases. Based on comparing the green index data and the transaction data, an award may be provided to the customer in accordance with at least one purchase criterion, e.g., the purchase price and/or the degree of greenness of the purchased item. The account data for the customer is consequently updated. The award may assume different forms, including green reward points that can be accumulated for a reward, cash back, and/or a contribution to a green organization.

According to an aspect of the embodiments, a computer system obtains purchase history data about past purchases from merchants by a customer. Based on location information about the merchants, the computer system determines a bundled travel plan so that the customer may travel to the merchants in a single trip to reduce a trip characteristic such as travel time, mileage, gasoline usage, or a combination thereof. The computer system may further send map information to a terminal device to display the bundled travel plan to facilitate navigation by the customer.

According to an aspect of the embodiments, a computer system provides a suggested purchase alternative for one of the past purchases by a customer. For example, the computer system may consider different factors including the relative degree of greenness between the past purchase and the suggested purchase alternative based on carbon footprints.

Aspects of the embodiments may be provided in a computer-readable medium having computer-executable instructions that, when executed, cause a computer or other apparatus to perform one or more of the process steps described herein.

These and other aspects of the embodiments are discussed in greater detail throughout this disclosure, including the accompanying drawings.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a suitable computing system environment that may be used according to one or more illustrative embodiments.

FIG. 2 shows an illustrative system for implementing example embodiments according to the present disclosure.

FIG. 3 shows a process that supports a green incentive program in accordance with an aspect of the disclosure.

FIG. 4 shows a process that creates green index data in accordance with an aspect of the disclosure.

FIG. 5 shows a process that supports a green program for recycled transaction cards in accordance with an aspect of the disclosure.

FIG. 6 shows a computing system that supports a green incentive program in accordance with an aspect of the disclosure.

FIG. 7 shows a process for identifying green merchants within a specified range of a mobile device in accordance with an aspect of the disclosure.

FIG. 8 shows a communications system that supports green purchases based on the process shown in FIG. 7 in accordance with an aspect of the disclosure.

FIG. 9 shows a process for generating recommendations for being greener in accordance with an aspect of the disclosure.

FIG. 10 shows a process for generating purchase recommendations in accordance with an aspect of the disclosure.

FIG. 11 shows a process that supports aggregate green purchases in accordance with an aspect of the disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

In the description herein, the following term is referenced.

Carbon footprint: A carbon footprint is the total set of greenhouse gas (GHG) emissions caused by an organization, event, product or person. For example, a carbon footprint may be expressed in terms of the amount of carbon dioxide (or its equivalent of other GHGs) emitted.

Environmentally green: Something or somebody is referred as being environmentally green when the said something or somebody is considered to inflict minimal or no harm on the environment. The said something or somebody may refer to goods, services, individuals, businesses, laws, guidelines, policies, and the like. Synonyms for environmentally green include environmentally friendly, eco-friendly, and nature friendly.

Green organization: An entity (typically non-profit) that advances laws, guidelines, policies, and/or public awareness about environmentally green issues.

In accordance with various aspects of the embodiments, an information technology (IT) system to process transaction data about a customer's purchase. The IT system may access green index data that includes information about environmentally green purchases for green purchases. Based on comparing the green index data and the transaction data, an award may be provided to the customer in accordance with at least one purchase criterion, e.g., the purchase price and/or the degree of greenness of the purchased item. The account data for the customer is consequently updated. The award may assume different forms, including a number of green reward points, cash back, and/or a contribution to a green organization.

According to various aspects of the embodiments, a customer may assume different forms, including an individual or corporate entity that interacts with a business.

According to an aspect of the embodiments, the green index data may be derived by obtaining a list of candidate merchants and comparing characteristics of a candidate merchant with at least one green factor. The candidate merchant may be included in the green index data when a merchant score is greater than a predetermined score, where the merchant score may be based on the green characteristics of the candidate merchant.

According to an aspect of the embodiments, a customer may request for a transaction card (e.g., credit card or debit card) that is constructed from recycled material (e.g., polyvinyl chloride (PVC)). A financial institute may charge the customer a predetermined amount of money and contribute it to a designated green organization.

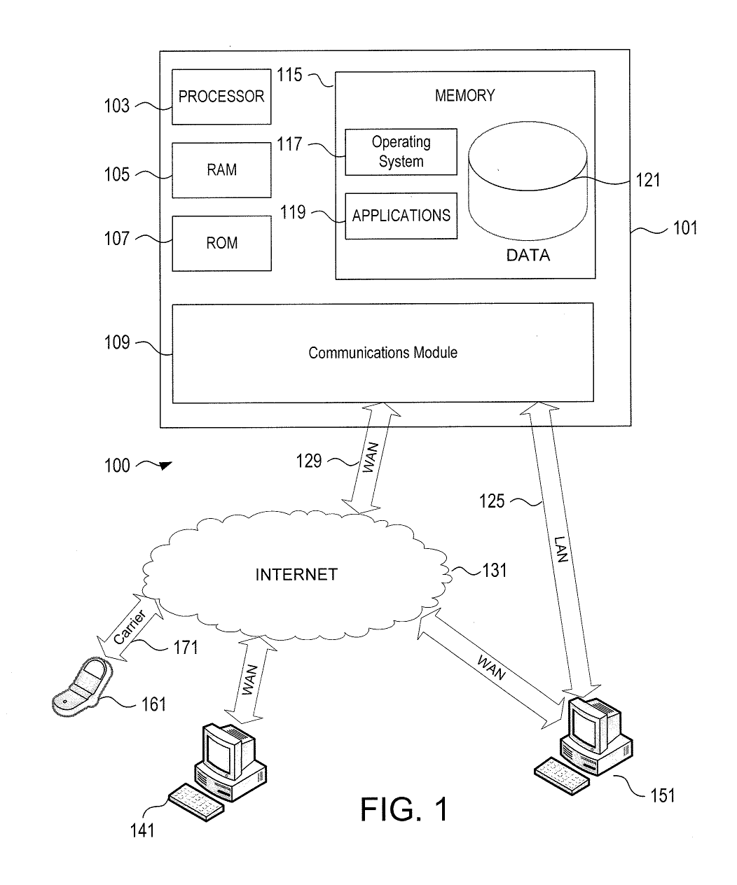

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

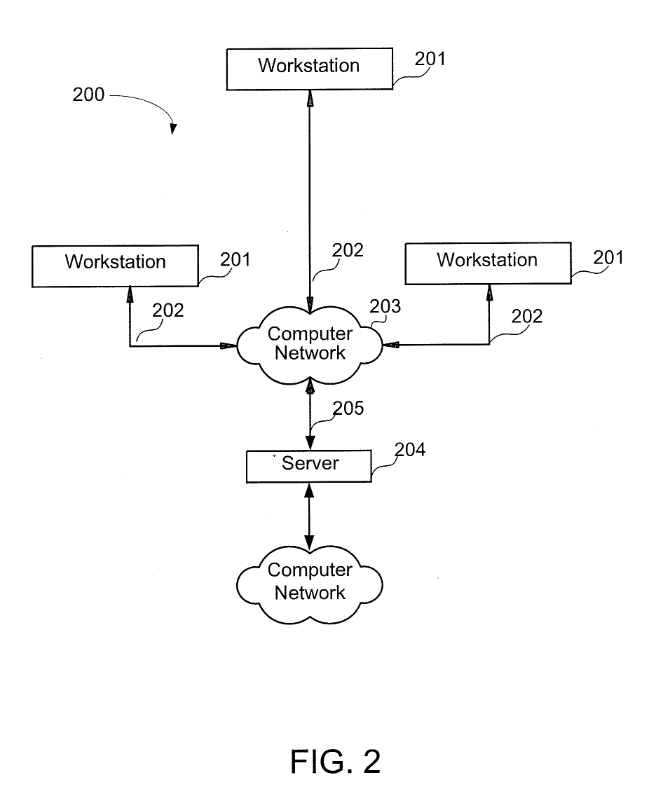

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

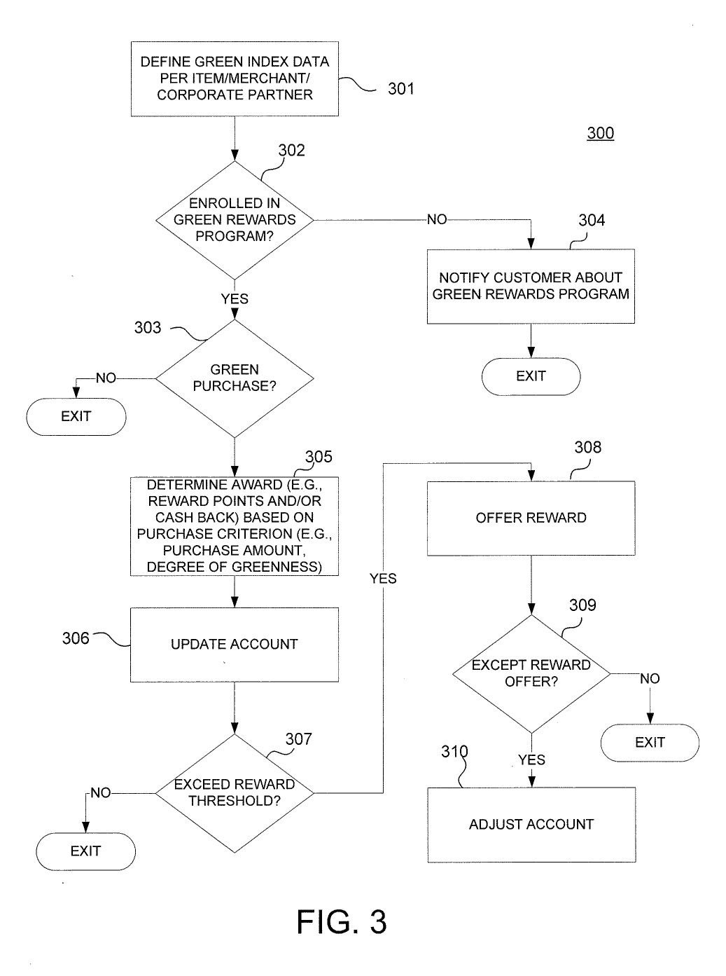

FIG. 3 shows process 300 that supports a green rewards program (green incentive program) in accordance with an aspect of the disclosure. The process 300 may be implemented by a computer system 601, for example. The blocks 301-310 may be arranged in other orders, some blocks may be omitted, and/or additional blocks may be added. The program may provide awards to customers who are enrolled in the program based on purchases, which may include green items and/or green services.

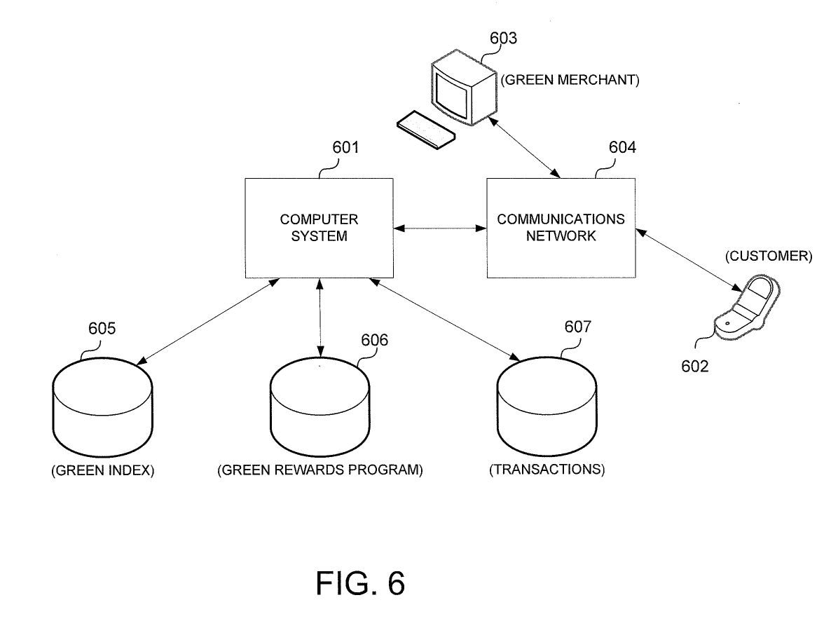

At block 301, green index data is specified for merchants, purchased items, purchased services, and corporate partners. As will be discussed, when a purchase has green characteristics specified in the green index data (for example, stored in memory device 605 as shown in FIG. 6), a customer may be given an award based on the purchase. The green characteristics may pertain to the merchant selling a product and/or service, the purchased item, or a corporate partner of the business supporting the green rewards program.

The green characteristics in the green index data may be based on one or more criteria provided by the business offering the green rewards program, the customer, and/or third party (e.g., a green organization). The criteria may include different green factors including the degree of greenness of an item, whether the item is a fair trade product, and the labor conditions associated with the manufacture of the item. For example, in order to qualify as a green purchase, the purchased item may have a carbon footprint less than a particular percentage of its total material and/or be purchased from a green merchant. This approach may also apply to services. For example, a business providing a service (e.g., home remodeling or home services) may use recycled material and recycle used material.

If the customer makes a purchase, process 300 determines whether the customer is enrolled in the green rewards program at block 302 and determines whether the purchase qualifies as a green purchase based on the green index data at block 303. For example, process 300 may compare transaction data with the green index data to determine whether purchased item is categorized as a green item and/or the purchased item was purchased from a green merchant. With some embodiments, if the customer makes a purchase but is not enrolled in the green rewards program, process 300 may generate a notification to the customer about the green rewards program at block 304. For example, as shown in FIG. 6, computer system 601 may send a text message or e-mail to the customer at terminal 602 through communications network 604 inviting the customer to enroll in the program.

An award may then be determined at block 305 for the green purchase. For example, reward points may be awarded to the customer based on the purchase price, e.g., one or more points for every dollar spent on a green purchase, where the reward points may be accumulated for a reward at a later time. Some embodiments may also provide awards in other forms. For example, the award may be cash back equal to a predetermined percentage of the purchase price. As another example, the purchase price may be rounded up, where the difference between the purchase price and the rounded amount is contributed to a designated green organization or credited to the customer by the business (e.g., financial institution) offering the green rewards program. Moreover, the customer may select one of the award options, e.g., green reward points, cash back, or rounding up the purchase price at the time the customer enrolls in the program or a time subsequent to enrollment.

With some embodiments, the award may be based on one or more green factors, including the degree of greenness of the purchased item, whether the purchased item is a fair trade product, and/or labor relations associated with the purchased item. The degree of greenness, for example, may be determined by one or more green characteristics of a purchased item. For example, the degree of greenness may be based on the amount of recycled material (which may be normalized to the total weight of the purchased item) and/or inversely on the carbon footprint (i.e., the larger the carbon footprint, the less degree of greenness).

With some embodiments, the award may be based on a combination of purchase factors, e.g., the purchase price and the degree of greenness of the purchased item. The purchase factors may be weighted and summed to obtain a purchase score from which the award is determined. As an example, a purchased green item has a price of $100 and a degree of greenness of 50% (where half of the material comprises recycled material). Also, assume that the purchased price is weighted by 0.75 and the degree of greenness is weighted by 0.25. The corresponding purchase score for this example is then calculated as: 100*0.75+50*0.25=87.5. With this example, one green reward point is awarded for each integer purchase score or 87 green reward points.

At block 306, process 300 updates the customer's account. For example, green reward points or cash back may be added to the customer's account, or a monetary contribution may be presented to a green organization on behalf of the customer. The business may further match the monetary contribution to advance the philanthropic goals of the business. With some embodiments, if the account amount exceeds a predetermined threshold at block 307, the customer may be offered a reward at block 308. For example, if the accumulated green awards points exceed 10,000 green reward points, the customer may be offered organically grown groceries. If the customer accepts the reward at block 309, the green awards points in the customer's account are adjusted at block 310 to reflect redemption of the offered reward.

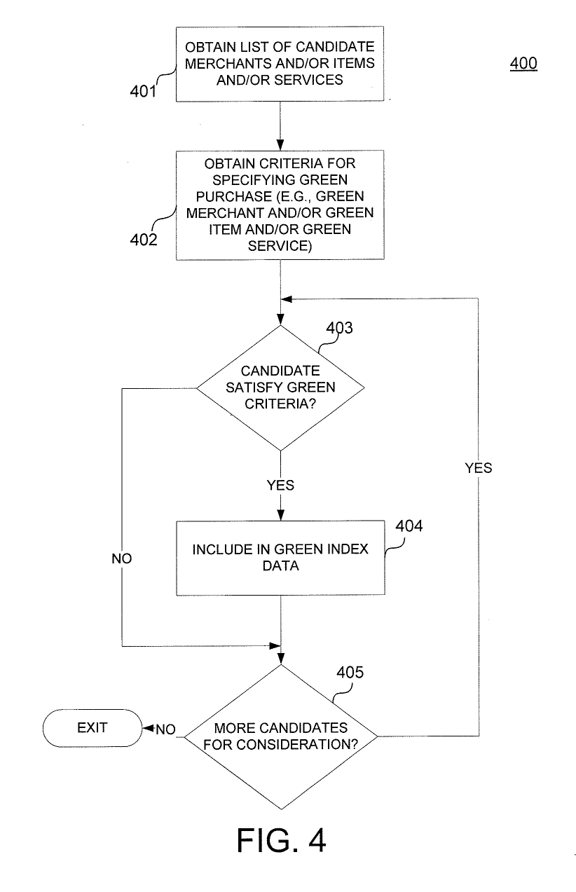

FIG. 4 shows process 400 that creates green index data (corresponding to block 301 in FIG. 3 and memory device 605 in FIG. 6) in accordance with an aspect of the disclosure. The process 400 may be implemented by a computer system 601, for example. The blocks 401-405 may be arranged in other orders, some blocks may be omitted, and/or additional blocks may be added.

At block 401, candidate merchants, items, and/or services are obtained so that process 400 can determine whether they are deemed as being green purchases for the green rewards program. At block 402, criteria are obtained that specify green characteristics (corresponding to green factors) that are needed for a merchant, item, or service to be considered green. For example, an item may be required to be constructed with at least a predetermined percentage of recycle material or have a carbon footprint less than a particular amount based on the size of the item. As another example, a merchant may be required to sell a predetermined percentage of green items and/or donate at least a predetermined percentage of profits to green organizations. The criteria at block 402 may be specified by the business supporting the green rewards program, and/or customer, third party, and/or social network of which the customer is a member.

With some embodiments, the green factors associated with a candidate merchant, item, or service may be weighted and summed to obtain a green score at block 403. If the green score satisfies a green criteria (e.g., exceeds a predetermined threshold), the candidate item, service, and/or merchant is included in the green index data at block 404. If additional candidates are to be evaluated at block 405, blocks 403 and 404 may then repeated.

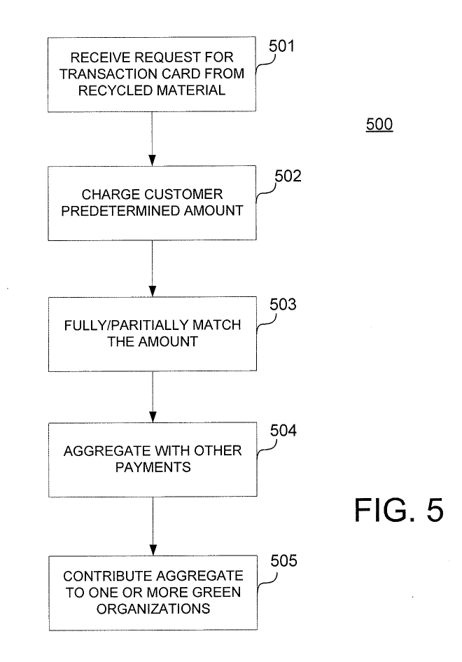

FIG. 5 shows process 500 that supports a green program for recycled transaction cards (e.g., credit cards and debit cards) in accordance with an aspect of the disclosure. The process 500 may be implemented by a computer system 601, for example. The blocks 501-505 may be arranged in other orders, some blocks may be omitted, and/or additional blocks may be added. For example, a customer may wish to express his/her commitment to environmentally-friendly causes. In order to do so, the customer may request, at block 501, a transaction card (possibly with a picture expressing environmentalism) that is constructed of recycled material (e.g., polyvinyl chloride (PVC)) from a financial institution. In exchange, the customer may be charged a predetermined amount of money at block 502, some or all of which may be contributed to one or more green organizations at block 505. With some embodiments, the financial institution may further match some or all of the predetermined amount in the contribution at block 503 and may aggregate, at block 504, the payments from other customers in the contribution.

FIG. 6 shows computer system 601 that supports a green incentive program in accordance with an aspect of the disclosure. A green merchant, using their computer 603, (hereinafter green merchant computer 603) may wish to participate in the green incentive program with a financial institution that operates computer system 601. Green merchant computer 603 may provide information about itself and offered items through communications network 604 so that green index data may be obtained and stored in memory device 605.

Customer using their computer 602 (hereinafter customer computer 602) may purchase a green item from the green merchant, and consequently the green merchant computer 603 may communicate a transaction record that is communicated and stored in memory device 607. Computer system 601 may then process transaction records from memory device 607 and compare the transaction data of the purchase with green index data from device 605 (for example, based on process 300 as shown in FIG. 3). Each of devices 605, 606, and 607 may include a database or other data storage device, memory, and/or computer readable medium. If computer system 601 determines that a purchase is in concert with the criteria of the green incentive program, then computer system 601 determines the award and updates the customer's green reward data in device 606. Customer computer 602 may be notified about the customer's green reward status through communications network 604 via messaging, e.g. text messaging or e-mail.

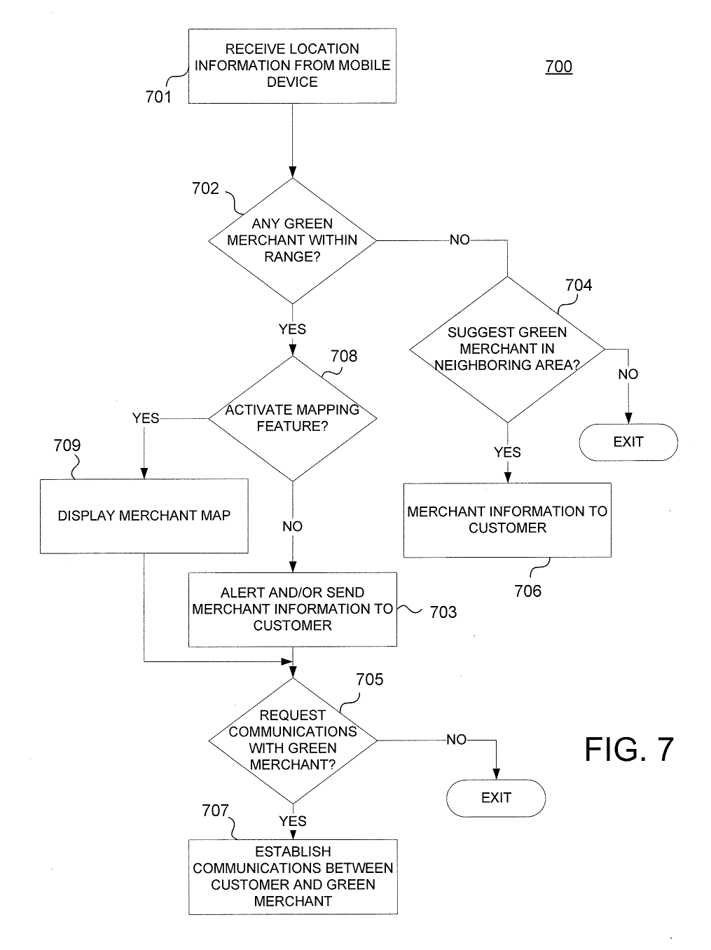

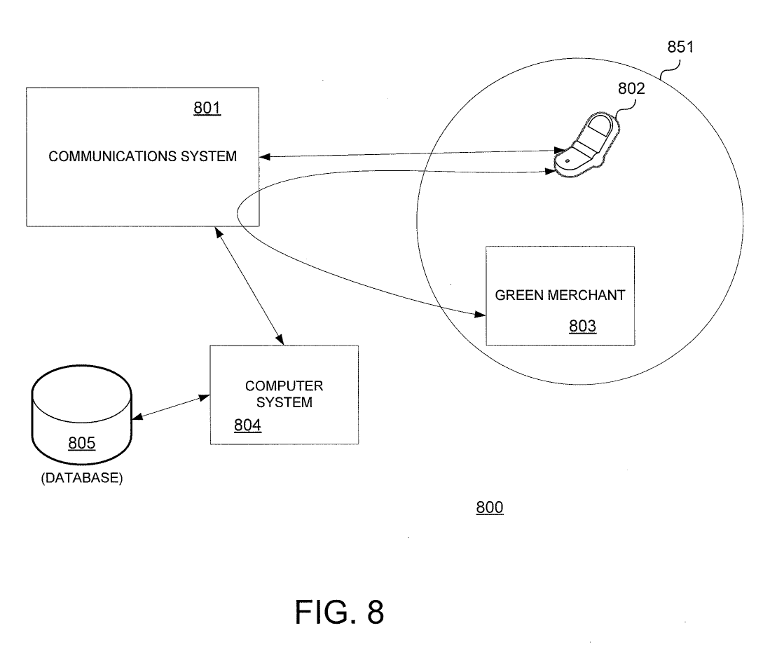

FIG. 7 shows process 700 (which may be performed by computer system 804 as shown in FIG. 8) for identifying green merchants within specified range 851 of a mobile device in accordance with an aspect of the disclosure. However, embodiments may support different types of green businesses including merchants, financial institutions, retailers, real estate sales, manufacturers, service providers, and transportation providers. The blocks 701-707 may be arranged in other orders, some blocks may be omitted, and/or additional blocks may be added. A mobile device may be, for example, a smart phone, a PDA, a cellular phone, a laptop computer, and/or other types of mobile devices that are portable and may access a network at different geographic locations.

At block 701 the customer's mobile device (corresponding to mobile device 802 as shown in FIG. 8) sends location information to computer system 804 through communications system 801. The communications system 801 may be a data network, a telephony network, etc. With some embodiments, the direction and speed of travel may be included with the location information. The location information may be determined by mobile device 802 in different ways. For example, mobile device may use Global Positioning System (GPS) information and/or augmented reality.

With augmented reality, for example, one or more surrounding images captured by a camera of mobile device 802 may be matched to one or more archived images stored at computing device 101 or server 204. The images may assume different forms, including still video images, multimedia files with audio and video content, and/or streaming video. Based on the matched archived image, computing device may be able to determine what the user of mobile device is viewing (e.g., Times Square in New York City, the Louvre Museum in Paris, or the Gold Gate Bridge in San Francisco). With some embodiments, computing device 101 or server 204 may then determine the approximate location of mobile device 802 or directly access merchant information based on the viewed image. The merchant information, for example, may identify green merchants in the vicinity of the viewed image.

With some embodiments, in addition to the location information, the customer may include a purchase category with the location information from mobile device 802 to computer system 804 so that the identification of green merchants can be more specific to the customer's needs. For example, the customer may input merchant search criteria via text, audio, and/or video specifying a product and/or service of interest. In addition, the customer (user) may provide a description of a green item that the customer desires so that a green merchant offering the item can be identified.

With some embodiments, the customer may include a merchant category with the location information. The customer may be interested only in a specific type of merchant, e.g., restaurant, clothing store, book store, jewelry store, and the like. Based on the specified merchant category, merchant information only for that type of green merchant may be provided by computer system 804.

At block 702 computer system 804 then matches the location information and/or the purchase category and/or a green item description to green index data that may be stored in memory device 805 (e.g., database). For example, computer system 804 may identify green merchants within a predetermined distance of the current mobile device's location (which may be referred as the current area of mobile device 802). The customer may specify the predetermined distance or the computer system 804 may base the distance based on a how frequently this or other customers have traveled a certain distance to make a green purchase (e.g., 70% of customers are willing to travel 0.5 miles or less). In another example, the computer system 804 may identify merchants carrying products and/or services matching the search criteria. The green index data may include green merchant information (e.g., text and graphical information about products and the merchant's website URL), and the merchant's location. The green index data may also provide a map providing the customer with turn by turn directions from their current location to the merchant's location. Computer system 804 may then send display information about one or more green merchants to mobile device 802 at block 703 when the merchant map feature is not activated as determined at block 708. For example, the merchant map feature may or may not be activated by a user input. The merchant map feature will be discussed in further detail.

With some embodiments, a range limit between the mobile device's location and green merchants may be determined. For example, a customer (user) may provide information through the mobile device that specifies the range limit. As another example, the range limit may be a function of the mobile device's location, where the value of the range limit is assessed from a lookup table based on the mobile device's location.

With some embodiments, at blocks 704 and 706 computer system 804 may provide merchant information about green merchants located in a neighboring area where mobile device 802 is located. For example, there may not be any green merchants within the current proximity of mobile device 802, or mobile device 802 may be moving in the direction of the neighboring area, e.g., with a predetermined angular range of the direction from mobile device 802 to the center of the neighboring area, where the neighboring area is a region abutting the current area of mobile device 802. Also, if mobile device 802 were moving away from the neighboring area, merchant information about merchants located in the neighboring area may not be sent at block 706.

When reviewing the displayed merchant information through mobile device 802, the customer may select to communicate directly with green merchant through communications system 801 by clicking on the merchant's website URL or telephone number. With some embodiments, computer system 804 may facilitate communications between the customer and the green merchant by initiating the communications at block 707. For example, computer system 804 may initiate a telephone call between mobile device 802 and green merchant 803 if the customer requests for further merchant information through communications system 801.

With some embodiments, a green merchant may target customers with specified customer characteristics that are within the vicinity of the green merchant at blocks 702 and 704. Customer characteristics may be based on different sources of information, including past purchase transactions accessed by computer system 804 from a transaction database. If the green merchant has an item that matches the customer characteristics, merchant information may be sent to the targeted customer at block 706. For example, the customer may have recently purchased jeans, and the green merchant may be offering a special sale on similar jeans constructed from environmentally-friendly material. If so, merchant information may then be sent to the targeted customer.

With some embodiments, mobile device 802 may comprise a smart phone, and the actions may be performed by an application executing on mobile device 802.

Referring to FIG. 7, when the merchant map feature is activate as determined at block 708, a merchant map may be displayed on mobile device 802 as performed at block 709. For example, green merchants may be displayed as icons on the map, where the size of an icon may be related to a measure of greenness of the merchant (e.g., the larger the icon, the greener the merchant). The measure may encompass green factors that include the percentage of offered items that are green and/or support of green organizations. Also, the size of the icon may be based on the proximity of the merchant from mobile device 802, where the icon may be larger for closer merchants and smaller for farther merchants. For example, the computer system 804 may divide the predetermined range into concentric distance zones. Example zones may include zone 1 from 0 to 0.25 miles away from the mobile device 802, zone 2 from 0.25 miles to 0.5 miles away, zone 3 from 0.5 miles to 1 mile away, and zone 4 from 1 mile to the predetermined range away. Icons associated with merchants located within zone 1 may be larger than the icons of merchants located within zone 2, which are larger than the icons in zone 3, and so forth. In another example, the computer system 804 may provide a maximum size for an icon within a predetermined distance (e.g., all merchants less than 0.2 miles), and may multiply a weighting factor to the maximum size based on the distance between the mobile device 802 and the green merchant 803. The weighting factor may decrease linearly and/or exponentially to a minimum icon size for a merchant located at the predetermined range 851.

With some embodiments, computer system 804 may adjust the size of an icon on a map as a function of the distance from the merchant and/or the greenness of the merchant. A greenness score for the merchant may be based on a set of green criteria, e.g., the percentages of sales that are contributed to green organizations and that are associated with green purchases. For example, a total score may be determined for the merchant that is based on a distance score (which may be inversely related to the distance between mobile device 802 and the merchant's location) and the greenness score. The merchants within a predetermined range of mobile device 802 may then be rank-ordered, where the size of each icon is based on the ranking. With some embodiments, a merchant may be displayed on a merchant map only if the greenness of the merchant is above a greenness threshold.

With some embodiments, a size of a merchant icon on a merchant map may be based on a price of an item, which may be retrieved from the merchant's website. For example, the lower the price for a green item with respect to other merchants, the larger the size of the merchant icon. Continuing the example, the lowest price for a green item (or within 10% of the lowest price) is given a certain number of points (e.g., 5 points), a mid-range price is given 0 points, and a highest price is given negative points (e.g., −5 points). Thus, the map may help a customer determine the most green item in view of cost.

With some embodiments, the size of a merchant icon may be based on any combination of the factors thereof.

The map feature performed at block 709 may also support a search feature, in which a user can input keywords of an item that the user wishes to purchase. The map feature may then display nearby green merchants (e.g., within a predetermined range) that offer the item.

The map feature may indicate merchants that use unsustainable and environmentally unfriendly practices. For example, such merchants may be displayed in red (or other color) on the map.

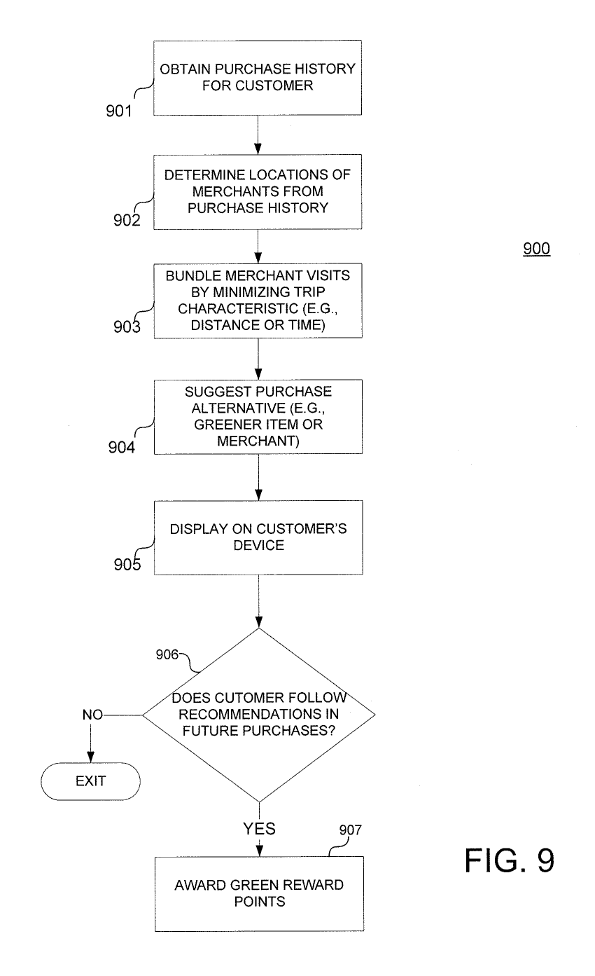

FIG. 9 shows process 900 for generating recommendations to a customer in order to be greener in relation to the customer's purchase history. For example, the customer may have bought non-recyclable, disposable items in the past. The process 900 may be implemented by a computing device 101 and/or server 204, for example. The blocks 901-907 may be arranged in other orders, some blocks may be omitted, and/or additional blocks may be added. Computing device 101 (as shown in FIG. 1) or server 204 (as shown in FIG. 2) may determine that a reusable item (e.g., cloth baby diapers versus plastic baby diapers) at approximately the same price should be recommended to reduce the resulting environmental impact. As another example, the customer may travel to different merchants on different days of the week. However, the total mileage of the trips may be reduced by shopping at the different merchants on the same day of the week.

At block 901, computing device 101 or server 204 obtains the purchase history of the customer over a time duration. For example, a customer may send a request through an application running on device 101 over a communications channel for suggested ways to be greener with respect to the customer's past behavior.

At block 902, computing device 101 or server 204 may determine the merchant locations for past purchases by the customer, where the merchants may or may not be green merchants. At block 903, computing device 101 or server 204 analyzes trips over a time duration (e.g., over the previous week) to determine whether separate trips to different merchants that may occur on different days or at different times of the day may be combined (bundled) into a single trip to reduce the environmental impact of the customer. Processing at block 903 may combine separate trips to reduce a trip characteristic (e.g., travel distance, time, and/or fuel usage) by combining the separate trips into a single trip. For example, the customer may go to the supermarket on Wednesday and to a clothing store on Friday. Processing at block 903 may consider different factors including total mileage of a bundled travel plan, total travel time that may be dependent on expected traffic conditions, total gasoline usage, or a combination of factors thereof. For example, the computing device 101 or server 204 may determine a distance between a customer's home and each of a group of merchants, as well as a distance between each of the merchants. The computing device 101 or server 204 may then identify one or more subsets of the merchants, where each merchant in a particular subset is within a predetermined distance of one another. The computing device 101 or server 204 may then designate a route between a customer's home and the merchants in the subset as a bundled travel plan. For example, the route may be from the customer's home to a first of the merchants in the subset, then from the first merchant to a second merchant in the subset, and so forth until reaching a last of the merchants in the subset. Thereafter, the route may direct the customer back home. The computing device 101 or server 204 may also reduce the number of merchants in a subset if total mileage, total travel time, and/or total fuel usage, respectively, exceeds a mileage, time, or usage threshold. The computing device 101 or server 204 may also determine a route for a bundled travel plan based on a customer's current geographic location, if they are not at home.

When considering total travel time, processing at block 903 may further consider minimizing a predicted total travel time and/or ensuring that the predicted total travel time is less than a predetermined time limit. For example, computing device 101 or server 204 may verify that the predicted total travel time is less than a time duration that may be specified by a customer. In order to reduce the total mileage, computing device 101 or server 204 may send a text message or e-mail suggesting that the customer combine the trips. With some embodiments, computing device 101 or server 204 may attempt to reduce the total travel time based on available traffic information and/or forecasted traffic information that may be based on past traffic patterns. For example, when a customer is about to leave, the computing device 101 or server 204 may electronically obtain a traffic report on each road included in a route for a bundled travel plan, and may change one or more roads in the route based on a traffic report indicating congestion.

Also, computing device 101 or server 204 may be cognizant of the ordering. For example, visiting a supermarket last may be preferable if the customer tends to buy perishable items, such as, for example, groceries.

With some embodiments, process 900 may also suggest green purchase alternatives at block 904 as displayed on the user's terminal device at block 905. Process 900 may analyze the purchase history of the customer and determine that some purchased items may be substituted with green items (i.e., items that are more environmentally friendly such that have a smaller carbon footprint). For example, green index data may cross reference items based on a degree of greenness. In addition, process 900 may recommend green merchants with respect to merchants who are not green for past purchases. If the customer follows some or all of the recommendations, the customer may be credited with green reward points in the green incentive program at blocks 906 and 907. For example, the computing device 101 or server 204 may determine that a customer has traveled X fewer miles by following bundled travel plan recommendations, and may award a predetermined number of green reward points for each mile not travelled. In another example, the computing device 101 or server 204 may determine that a customer has spent Y fewer minutes sitting in their car in traffic by following bundled travel plan recommendations, and may award a predetermined number of green reward points for each minute saved.

With some embodiments, at block 904, computing device 101 or server 204 may propose a merchant substitution for one or more merchants from the customer's past purchases. For example, a proposed merchant may be a green merchant while the previous merchant is not or may be greener than the previous merchant. As another example, a proposed merchant may offer similar green items as the previous merchant but may be located closer to the customer's home so that the mileage and/or trip time for a bundled trip may be reduced.

With some embodiments, the results for bundling by processing at block 903 may be displayed on a terminal device at block 905. For example, map information may be sent from computing device 101 (shown in FIG. 1) or server 204 (shown in FIG. 2) to the terminal device. The map information may include a route for traveling to the merchants for a bundled travel plan. The terminal device may include navigational capabilities and may interact with a separate navigational device that instructs the customer about traveling to the merchants during the bundled travel plan.

With some embodiments, previously purchased products that are environmentally unfriendly may be identified at block 904 so that the user is encouraged to avoid purchasing such products in the future. Process 900 may also suggest green alternatives to such previously purchased products.

With some embodiments, the customer's communications terminal may comprise a smart phone, and the actions may be performed by an application executing on the communications terminal.

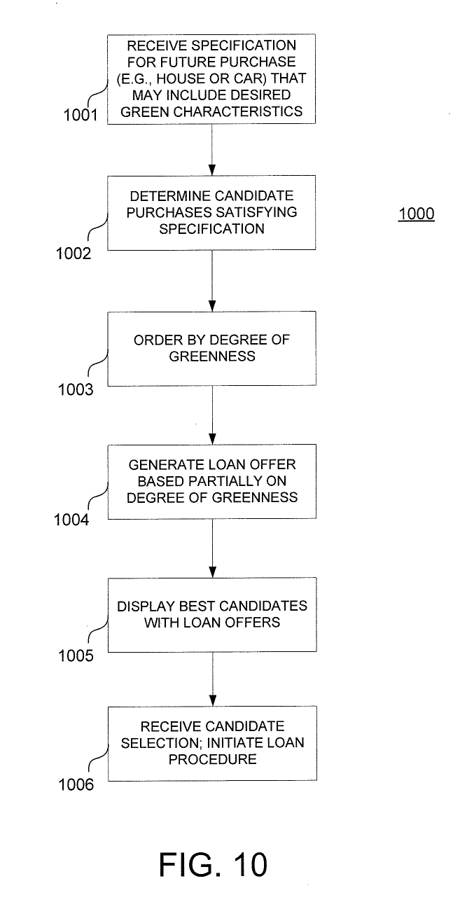

FIG. 10 shows process 1000 that may performed by computing device 101 (as shown in FIG. 1) or server 204 (as shown in FIG. 2) for generating purchase recommendations in accordance with an aspect of the disclosure. The blocks 1001-1006 may be arranged in other orders, some blocks may be omitted, and/or additional blocks may be added. Process 1000 may also provide corresponding loan offers with the purchase recommendations. For example, a customer may provide specifications for a car or a house. Process 1000 may then determine candidate purchases based on a degree of greenness. The loan conditions (e.g., the interest rate) may be partially based on the degree of greenness of the candidate purchase in conjunction with traditional loan factors.

At block 1001, computing device 101 or server 204 receives a specification from a customer regarding a future purchase. For example, the future purchase may be for a car, house, boat, or other item that often requires that the customer obtain financing in order to consummate the purchase. For example, the customer may specify the desired square footage, price range, and fuel consumption and/or fuel costs to heat and/or cool the house.

At block 1002, computing device 101 or server 204 uses the received specification to identify candidate purchases. The specification may include one or more green criteria that characterize a candidate purchase. Computing device 101 or server 204 attempts to best match the criteria provided in the specification as well as determine a degree of greenness for each candidate purchase. The degree of greenness may be determined by weighting green characteristics of the candidate purchase and summing the weighted green characteristics. For example, a customer may wish to purchase a green car within a specified price range. Computing device 101 or server 204 may considered various green characteristics of candidate purchases (which may be accessed from green index data in a memory device), weight the green characteristics, and sum the weighted characteristics to obtain the degree of greenness. For example, with a car, green characteristics may include miles per gallon, type of fuel (e.g., octane rating), and the weight of the car. The weighting factors typically vary in magnitude between 0 and 1 (or other ranges) and may be negative. After the degree of greenness has been determined for each candidate purchase, the candidate purchases may be ordered by the degree of greenness when displayed to the customer, as depicted in block 1003 of process 1000.

With some embodiments, process 1000 may also generate a loan offer for one or more of the candidate purchases at block 1004. For example, a financial institution may consider the degree of greenness as one of factors when determining the loan conditions, where the rate of interest may be partially reduced based on the increased degree of greenness. With some embodiments, the financial institution may consider other factors including the financial risk of the customer and/or the financial risk of the candidate purchase (e.g., a house located near a flood plain). At block 1005, computing device 101 or server 204 may send the purchase recommendations (for example though text messaging, e-mail, and/or graphical display) for each of the candidate purchases and corresponding loan offers for presentation to the customer by a customer's device (e.g., smart phone, computer, etc.).

With some embodiments, the customer may select one of the displayed candidate purchases and the corresponding loan offer. Upon receiving an indication of the selection indicating a desire to accept the corresponding loan offer, computer device 101 or server 204 may, at block 1006, initiate a loan process in accordance with current loan procedures of the financial institution.

With some embodiments, when the customer has selected one of the candidate purchases, the financial institution may determine an award to be presented to the candidate and/or to another person and/or organization. The award may be determined by a number of factors, including the degree of greenness and/or price of the selected item. Also, the customer may designate that, in lieu of a personal award, a contribution should be presented to a green organization on behalf of the customer.

With some embodiments, the customer's communications terminal may comprise a smart phone, and the actions may be performed by an application executing on the communications terminal.

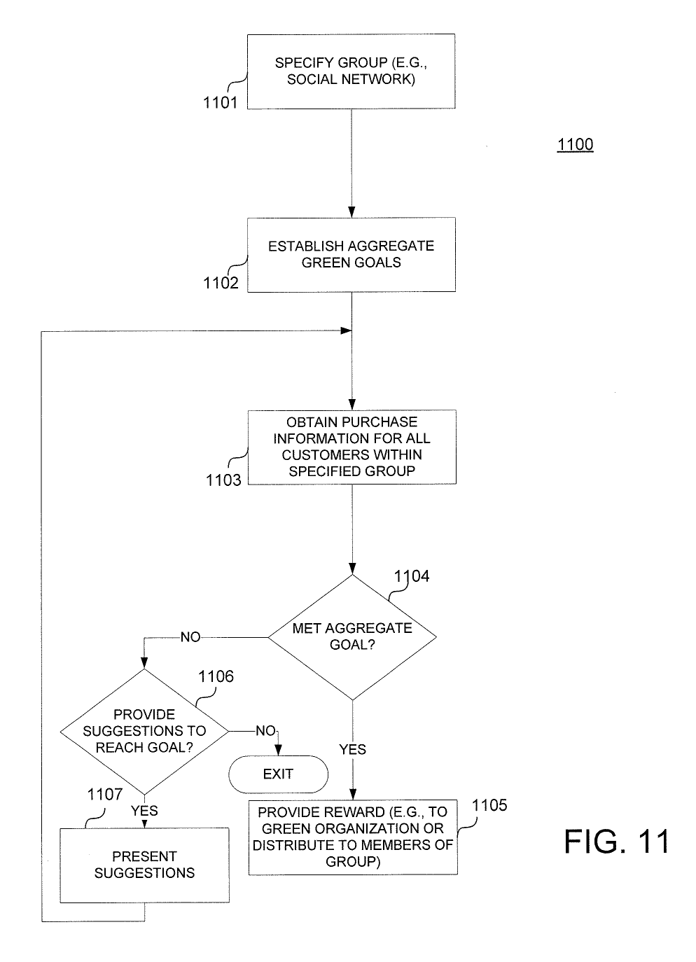

FIG. 11 shows process 1100 that supports aggregate green purchases in accordance with an aspect of the disclosure. For example, a group (e.g., a social network or college fraternity) may determine an aggregate green goal among the members of the group. For example, the group may be established through social networking, and if the agreed aggregate goal is achieved, a reward may be provided to members of the group and/or to a third party (e.g., a designated green organization). The green goal may comprise one or more criteria. For example, a criterion may specify that at least a predetermined percentage of purchases for the group are for green items.

Social networking may assume different types of services that are based on different networking criteria. Different types of social networking services may be directed to category places (e.g., as former school year or classmates), means to connect with friends (e.g., with self-description pages), and/or a recommendation system linked to trust. Examples of social networking may span a worldwide (e.g., Facebook and Twitter®) or a regional basis (e.g., Nexopia in Canada and Skyrock in parts of Europe).

The blocks 1101-1107 may be arranged in other orders, some blocks may be omitted, and/or additional blocks may be added.

At block 1101, a group is specified that may include a plurality of customers. The group decides on an aggregate green goal and specifies the goal at block 1102. For example, the group may enroll in a promotional program with a financial institution (e.g., credit card company), where the goal specifications are stored at a computing system. Continuing the example, one or more members of the group may send goal information to computer to computing device 100 in order to establish an aggregate goal to purchase at least $10,000 with at least 50% of the purchase price being attributed to green items. However, with some embodiments, the aggregate green goal may be established by another entity such as the financial institution or a third party.

With some embodiments, the business offering the reward program may send a list of suggested green criteria to the members of the group. The reward may be predicated on the group attaining one or more of the green criteria. For example, a green criterion may specify that the members of the group purchase green items for at least a predetermined purchase price. With some embodiments, each of the group members may select some or all of the suggested green criteria. Based on the selections from the group members, the business may determine which green criteria should be met in order for the group to obtain a corresponding reward. For example, a voting procedure may be used, where the determined green criteria are determined on a majority basis.

At block 1103, computing device 101 or server 204 accesses the transaction records for the members of the group and analyzes the records to determine whether the group has achieved the aggregate goal at block 1104. For example, the green goal may be attained if all of the green criteria have been satisfied or if at least a specified subset of the green criteria has been satisfied. If so, a reward may be provided at block 1105. For example, a financial institution may provide a reward (e.g., green reward points) to each of the group members and/or may contribute an amount to a green organization based on the aggregate purchases.

With some embodiments, group members may vote on selecting an award at block 1105. For example, the members may select from different award choices, e.g., a contribution to a designated green organization, a monetary award to each of the group members, an accumulation of green reward points, or a gift item. A voting procedure may be used, for example, where the award is determined on a majority basis.

With some of the embodiments, a current status for achieving the aggregate green goal may be presented to a member of the group. For example, an application executing on the member's mobile device may retrieve current status information from computing device 101 or server 204 and may then display the status in a text and/or graphical format on the mobile device's display. For example, a bar graph may be displayed to show the completed purchase amount at the current time and the remaining purchase amount to achieve the aggregate goal.

With some embodiments, recommendations may be provided to members of the group to achieve the aggregate goal at blocks 1106 and 1107. Process 1100 may recommend that someone in the group consider purchasing a particular green item rather than a non-green item that was previously purchased by another group member. For example, process 1100 may determine from transaction data that one member has already purchased an item but a green item could have been purchased instead. At block 1107, process 1100 may inform the other members to consider the identified green item rather than buying the purchased item as did the other member. As another example, a member may inquire whether a green item is available in lieu of an identified item at block 1106. At block 1107, process 1100 may suggest the green item.

Process 1100 may be performed on computing device 101 or server 204. Also, an associated application may execute on group member's terminal device.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. An apparatus comprising:
at least one memory; and
at least one processor coupled to the at least one memory and configured to perform, based on instructions stored in the at least one memory:
obtaining purchase history data about past purchases by a customer;
obtaining location information about merchants for the past purchases;
determining a bundled travel plan for travel to a subset of the merchants by identifying a travel route between the merchant subset that reduces a trip characteristic; and
sending map information to a terminal device for causing the terminal device to display the travel route.

2. A computer-assisted method for processing data, the method comprising:
obtaining, by a computer system, purchase history data about past purchases by a customer;
obtaining, by the computer system, location information about merchants for the past purchases; and
determining a bundled travel plan for travel to a subset of the merchants by identifying a travel route between the merchant subset that reduces a trip characteristic.

3. The method of claim 2, wherein the customer is enrolled in a green rewards program, the method further comprising:
awarding a green reward when the customer follows a recommendation contained in recommendation information for future purchases.

4. The method of claim 3, wherein the green reward comprises green reward points.

5. The method of claim 3, wherein the green reward comprises a contribution to a green organization.

6. The method of claim 2, further comprising:
generating an indication of a suggested purchase alternative for one of the past purchases, wherein the purchase alternative has a greater degree of greenness than said one past purchase; and
inserting the indication in recommendation information.

7. The method of claim 6, wherein a first carbon footprint for the past purchase is larger than a second carbon footprint for the purchase alternative.

8. The method of claim 2, wherein the determining comprises:
reducing a total number of miles for traveling to the merchants based on the location information about the merchants for the past purchases.

9. The method of claim 2, wherein the determining comprises:
obtaining forecasted traffic information; and
reducing a predicted total travel time for traveling to the merchants based on the forecasted traffic information.

10. The method of claim 9, further comprising:
verifying that the predicted total travel time is less than a predetermined time limit.

11. The method of claim 2, wherein the bundling comprises:
reducing a total gasoline usage for traveling to the merchants.

12. The method of claim 2, wherein the providing comprises:
sending map information to a terminal device, wherein the map information causes the terminal device to display the bundled trip plan.

13. An apparatus comprising:
at least one memory; and
at least one processor coupled to the at least one memory and configured to perform, based on instructions stored in the at least one memory:
obtaining purchase history data about past purchases by a customer, wherein the purchase history data includes location information about merchants for the past purchases;
generating recommendation information about a suggested purchase alternative for one of the past purchases, wherein the suggested purchase alternative has a greater degree of greenness than said one past purchase; and
sending the recommendation information to a terminal device.

14. The apparatus of claim 13, wherein the at least one processor is further configured to perform:
determining a bundled travel plan to the merchants by the customer in a single trip to reduce a trip characteristic; and
inserting bundled trip information into the recommendation information.

15. The apparatus of claim 14, wherein the bundling comprises reducing a total number of miles for traveling to the merchants based on the location information about the merchants for the past purchases.

16. The apparatus of claim 14, wherein the bundling comprises obtaining forecasted traffic information and reducing a predicted total travel time for traveling to the merchants based on the forecasted traffic information.

17. The apparatus of claim 14 wherein the at least one processor is further configured to perform:
sending map information to a terminal device, wherein the map information causes the terminal device to display a trip plan for the bundling of the future purchases.

18. A non-transitory computer-readable storage medium storing computer-executable instructions that, when executed, cause a processor at least to perform operations comprising:
obtaining purchase history data about past purchases by a customer;
obtaining location information about merchants for the past purchases;
determining a bundled travel plan for travel to a subset of the merchants by identifying a travel route between the merchant subset that reduces a trip characteristic; and
sending map information to a terminal device for causing the terminal device to display the travel route.

19. The computer-readable medium of claim 18 wherein the computer-executable instructions, when executed, cause the processor to perform:
generating an indication of a suggested purchase alternative for one of the past purchases, wherein the suggested purchase alternative has a greater degree of greenness than said one past purchase; and
inserting the indication in recommendation information to the terminal device.

20. The computer-readable medium of claim 18, wherein the computer-executable instructions, when executed, cause the processor to perform:
reducing a total number of miles for traveling to the merchants based on the location information about the merchants for the past purchases.

21. The method of claim 2, further comprising:
substituting one of the merchants with an alternative merchant to reduce the trip characteristic.

22. The method of claim 2, further comprising:
substituting one of the merchants with an alternative merchant when the alternative merchant has a higher degree of greenness than said one merchant.
